(19) United States
(12) Patent Application Publication
(10) Pub. No.: US 2025/0329955 A1
(43) Pub. Date: Oct. 23, 2025

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yusuke YAMADA, Mie (JP); Katsuhiko AIZAWA, Mie (JP)

(21) Appl. No.: 18/868,176

(22) PCT Filed: May 10, 2023
(86) PCT No.: PCT/JP2023/017564

§ 371 Date: Nov. 22, 2024

(30) Foreign Application Priority Data
May 24, 2022 (JP) 2022-084583

(51) Int. Cl. H01R 13/415; H01R 13/506; H01R 13/56

(52) U.S. Cl. CPC H01R 13/415; H01R 13/506; H01R 13/56; H01R 2201/20; H01R 2201/26

(57) ABSTRACT

A connector 10 includes a wire 12 formed by covering a plurality of strands 14, a terminal fitting 20 connected to an end part of a strand exposed portion 18a, in which the strands 14 are exposed by stripping an insulation coating 16 in an end of the wire, and a connector housing 22 for accommodating the terminal fitting 20 and the wire 12. The connector housing 22 includes a wire press-fit portion 41. A strand exposed portion 18b includes a strand welded portion 24 formed by welding and integrating the strands 14. The strand welded portion 24 is press-fit and held in the wire press-fit portion 41.

### TECHNICAL FIELD

The present disclosure relates to a connector.

### BACKGROUND

Patent Document 1 discloses a connector in which a terminal fitting connected to a wire end is accommodated in a connector housing. In such a connector, there is a possibility that an external force is applied to the wire due to vehicle vibration during installation in a vehicle and sliding wear occurs at a contact point between the terminal fitting and a mating terminal connected to the terminal fitting. Thus, a structure for holding the wire in a part of a wire holding portion by newly adopting the wire holding portion and, on the other hand, holding the end of the wire not to relatively move with respect to the connector housing by fixing the other part of the wire holding portion to the connector housing.

### PRIOR ART DOCUMENT

### Patent Document

Patent Document 1: JP 2021-131941 A

### SUMMARY OF THE INVENTION

### Problems to be Solved

However, in the connector described in Patent Document 1, the wire holding portion needs to be newly adopted, there are many components and, associated with that, the connector may be enlarged or manufacturing cost may increase.

Accordingly, a connector is disclosed which can reduce a possibility of causing contact sliding wear due to the transfer of an external force applied to a wire to a terminal fitting with a small number of components.

### Means to Solve the Problem

The present disclosure is directed to a connector with a wire formed by covering a plurality of strands by an insulation coating, a terminal fitting connected to an end part of a strand exposed portion, the strands being exposed in the strand exposed portion by stripping the insulation coating in an end of the wire, and a connector housing for accommodating the terminal fitting and the wire, the connector housing including a wire press-fit portion, the strand exposed portion including a strand welded portion formed by welding and integrating the strands, and the strand welded portion being press-fit and held in the wire press-fit portion.

### Effect of the Invention

According to the connector of the present disclosure, it is possible to provide a connector capable of suppressing a problem of transferring an external force applied to a wire to a terminal fitting with a small number of components.

### BRIEF DESCRIPTION OF THE DRAWINGS

FIG. 1 is a perspective view showing a connector according to one embodiment.

FIG. 2 is a bottom view of the connector shown in FIG. 1.

FIG. 3 is a section along III-III in FIG. 2.

FIG. 4 is a section along IV-IV in FIG. 2.

FIG. 5 is a perspective view showing a disassembled state of the connector shown in FIG. 1 when viewed from a bottom surface side.

FIG. 6 is an exploded perspective view of a connector body constituting the connector shown in FIG. 1.

FIG. 7 is a perspective view showing a first resin component constituting the connector shown in FIG. 1 when viewed from the bottom surface side.

FIG. 8 is a perspective view showing a second resin component constituting the connector shown in FIG. 1.

FIG. 9 is a perspective view showing a mutually assembled state of the first resin component shown in FIG. 7 and the second resin component shown in FIG. 8.

FIG. 10 is a perspective view showing a shield shell constituting the connector shown in FIG. 1.

### DETAILED DESCRIPTION TO EXECUTE THE INVENTION

### Description of Embodiments of Present Disclosure

First, embodiments of the present disclosure are listed and described.

The connector of the present disclosure is provided with a wire formed by covering a plurality of strands by an insulation coating, a terminal fitting connected to an end part of a strand exposed portion, the strands being exposed in the strand exposed portion by stripping the insulation coating in an end of the wire, and a connector housing for accommodating the terminal fitting and the wire, the connector housing including a wire press-fit portion, the strand exposed portion including a strand welded portion formed by welding and integrating the strands, and the strand welded portion being press-fit and held in the wire press-fit portion.

According to the connector of the present disclosure, the strand exposed portion includes the strand welded portion formed by welding and integrating the strands, and the strand welded portion is press-fit and held in the wire press-fit portion provided in the connector housing. The strand welded portion has improved rigidity as compared to the plurality of strands in a part of the wire covered by the insulation coating and not welded. In this way, a displacement of the wire with respect to the connector housing is advantageously suppressed or hindered only by press-fitting and holding the strand welded portion in the wire press-fit portion of the connector housing. As a result, it is possible to reduce a possibility of causing contact sliding wear due to the transfer of an external force applied to the wire to the terminal fitting. In addition, since the structure of the present disclosure can be realized by providing the wire press-fit portion in an existing connector housing and providing the strand welded portion in a strand exposed portion of an existing wire, a size reduction of the connector and cost reduction can be advantageously achieved by avoiding an increase in the number of components.

Preferably, the wire press-fit portion includes a groove portion for accommodating the strand welded portion inserted thereinto and a pressing protrusion for pressing the strand welded portion toward a bottom part of the groove portion. Since the strand welded portion can be pressed toward the bottom part of the groove portion with the strand welded portion accommodated in the groove portion, the retention of the strand welded portion by the wire press-fit portion can be advantageously improved.

Preferably, the groove portion of the wire press-fit portion and the strand welded portion extend in an axial direction of the wire while having similar cross-sectional shapes. This is because the retention of the strand welded portion by the groove portion can be improved since the groove portion of the wire press-fit portion and the strand welded portion have similar cross-sectional shapes.

Preferably, a crush rib projects on a facing surface of the groove portion facing the strand welded portion. This is because the retention of the strand welded portion by the groove portion when the strand welded portion is press-fit into the groove portion can be further improved since the crush rib is provided on the facing surface facing the strand welded portion in the groove portion.

Preferably, the connector housing includes a first resin component having the groove portion and a second resin component having the pressing protrusion, and the first and second resin components are assembled in an approach direction of the pressing protrusion toward the groove portion and the strand welded portion is sandwiched between the groove portion and the pressing protrusion in the approach direction. Since the strand welded portion is sandwiched between the groove portion of the wire press-fit portion and the pressing protrusion by assembling the first and second resin components of the connector housing, the fixing of the strand welded portion to the connector housing can be realized without complicating an assembly operation.

Preferably, the first and second resin components are assembled by fitting and locking a resilient lock piece provided on one of the first and second resin components to a lock claw provided on the other, a crush rib is provided on a contact surface of the pressing protrusion with the strand welded portion, and the crush rib is pressed into contact with the strand welded portion in a state of the resilient lock piece fit and locked to the lock claw. This is because the resilient lock piece is allowed to be fit and locked to the lock claw and rattling due to a locking gap between the resilient lock piece and the lock claw is prevented by the resilient deformation of the crush rib.

Preferably, the connector housing includes a voltage detection hole for exposing the strand welded portion to outside. By including the voltage detection hole, the strand welded portion can be used as a voltage detection part for energization inspection. The voltage detection hole can be provided with a high degree of design freedom as compared to an accommodation region for the terminal fitting having a complicated structure.

Preferably, the voltage detection hole penetrates through inside of the pressing protrusion and is open in a projecting end surface of the pressing protrusion and a surface of the connector housing. This is because the voltage detection hole can be provided near the strand welded portion, utilizing an internal region of the pressing protrusion, and can be provided with good space efficiency.

Preferably, the connector is further provided with a plug member for sealing the voltage detection hole and a plug member holder for holding the plug member, the plug member holder being assembled with the connector housing directly or via another member. Since the plug member for sealing the voltage detection hole is held on the plug member holder and assembled with the connector housing, the handleability and assemblability of the relatively small plug member can be improved. Note that, if the connector housing is covered by another member such as a shield shell, a through hole can be provided in the shield shell, the plug member holder is assembled with the shield shell and the plug member can be mounted into the voltage detection hole through the through hole.

Preferably, the wire includes a tolerance absorbing portion capable of being curved and deformed between the end part of the strand exposed portion and the strand welded portion, the wire press-fit portion and the strand welded portion extend in an axial direction of the wire, and an axial length of the strand welded portion is longer than an axial length of the wire press-fit portion. Since the wire includes the tolerance absorbing portion capable of being curved and deformed between the end part of the strand exposed portion and the strand welded portion, a tolerance can be absorbed by the curved deformation of the tolerance absorbing portion. Further, since the axial length of the strand welded portion is longer than that of the wire press-fit portion, the arrangement of the strand welded portion in a press-fit state over the entire length of the wire press-fit portion can be advantageously realized while a change in the extra length of the tolerance absorbing portion is dealt with. In this way, both tolerance absorbance and the fixing stability of the wire to the connector housing can be realized.

### Details of Embodiment of Present Disclosure

A specific example of a connector of the present disclosure is described with reference to the drawings. Note that the present disclosure is not limited to these illustrations, but is represented by claims and intended to include all changes in the scope of claims and in the meaning and scope of equivalents.

### Embodiment

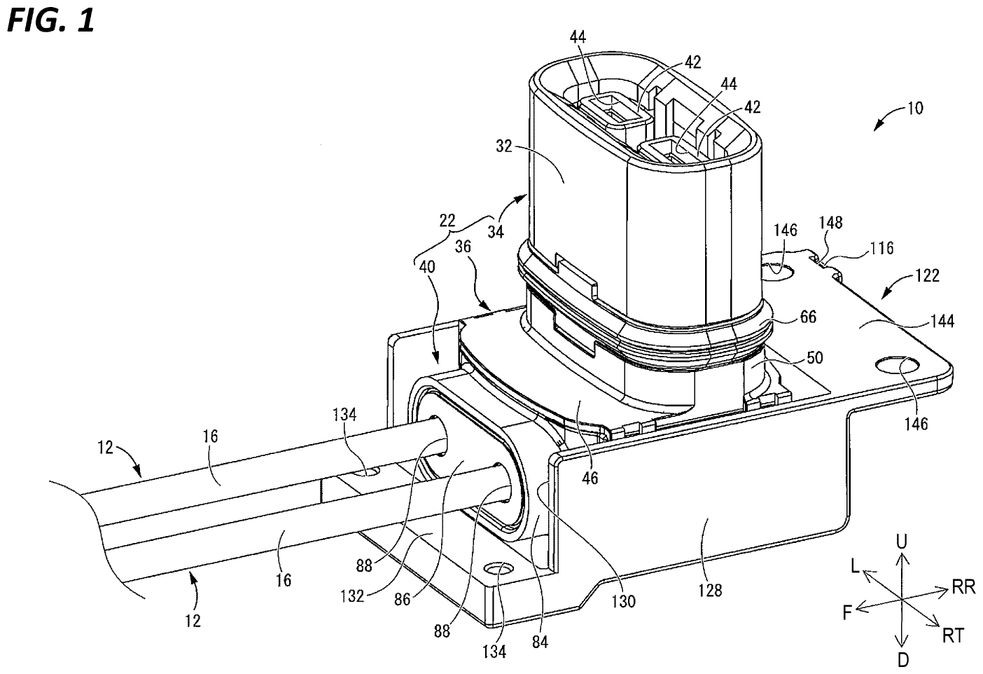

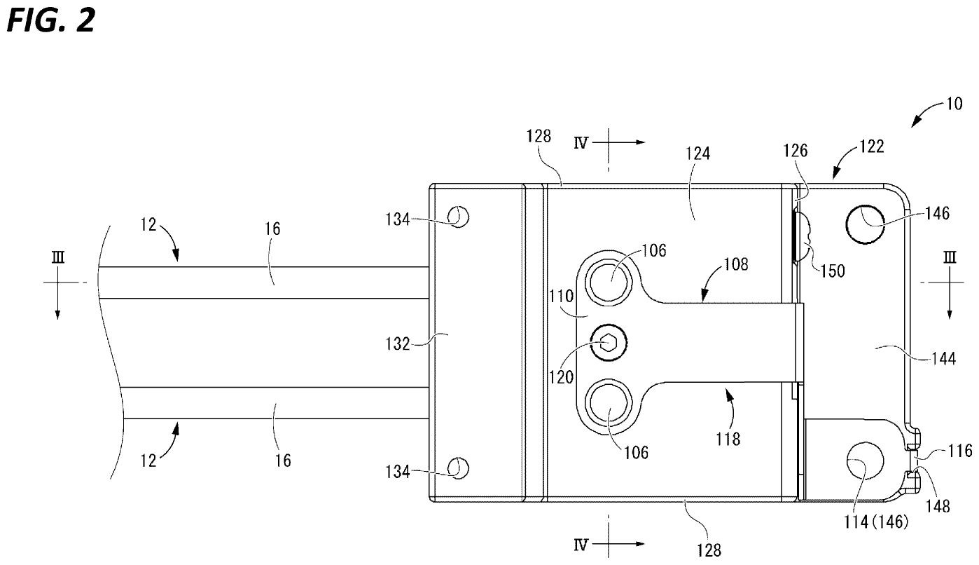

Hereinafter, a connector 10 of one embodiment of the present disclosure is described using FIGS. 1 to 10. The connector 10 is for electrically connecting in-vehicle devices, an in-vehicle device is electrically connected to wires 12 extending in a direction toward a left lower side in FIG. 1, and terminals of an unillustrated mating in-vehicle device are electrically connected from above in FIG. 1. Note that the connector 10 can be arranged in an arbitrary orientation, but a vertical direction, a lateral direction and a front-rear direction are described based on a vertical direction, a lateral direction and a front-rear direction shown in FIG. 1. Further, for a plurality of identical members, only some members may be denoted by a reference sign and the other members may not be denoted by the reference sign.

### Connector 10

The connector 10 of this embodiment includes the wires 12 each configured such that a core wire 14 formed of a plurality of strands is covered by an insulation coating 16, terminal fittings 20 connected to end parts of strand exposed portions 18, in which the strands (core wires 14) are exposed by stripping the insulation coatings 16 in ends of the wires 12, and a connector housing 22 for accommodating the terminal fittings 20 and the wires. Note that, in this embodiment, a pair of the wires 12, 12 are provided side by side in the lateral direction, and the terminal fitting 20 is provided on an end part of each wire 12. Further, although the plurality of strands are shown as one core wire 14 for easy understanding in figures, the core wire 14 is configured by twisting the plurality of strands.

### Wires 12

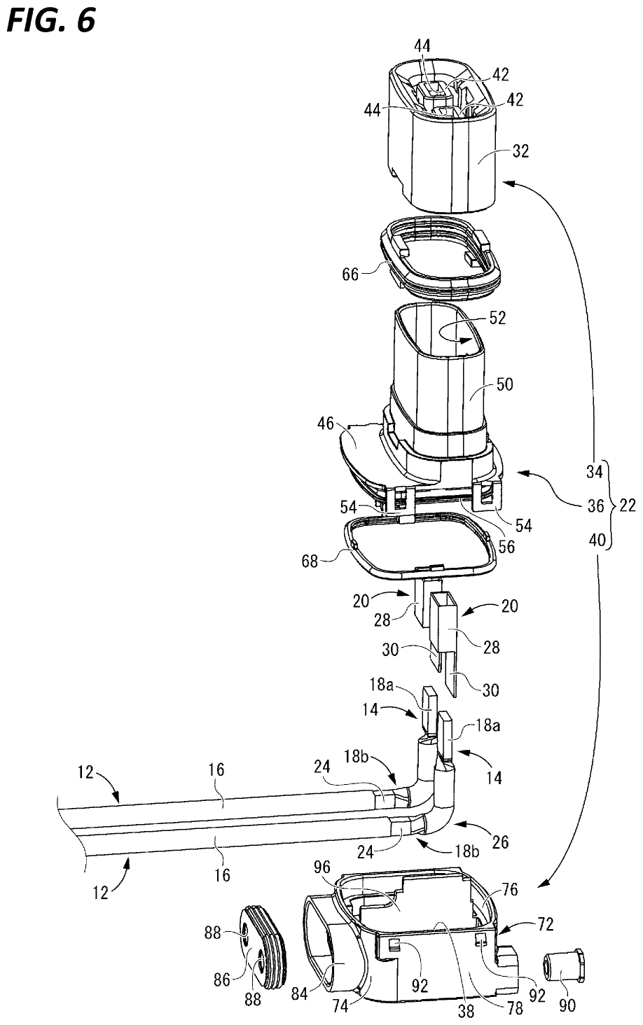

In each wire 12, the plurality of strands constituting the core wire 14 are respectively made of metal excellent in electrical conductivity such as copper (including copper alloy) or aluminum (including aluminum alloy). In this embodiment, each strand is made of aluminum. As also shown in FIG. 6, each wire 12 extends in the front-rear direction as a whole and is curved upward in a rear end part. The insulation coatings 16 are stripped in upper end parts of the respective wires 12 to provide strand exposed portions 18a, and the terminal fitting 20 is connected to each of these strand exposed portions 18a.

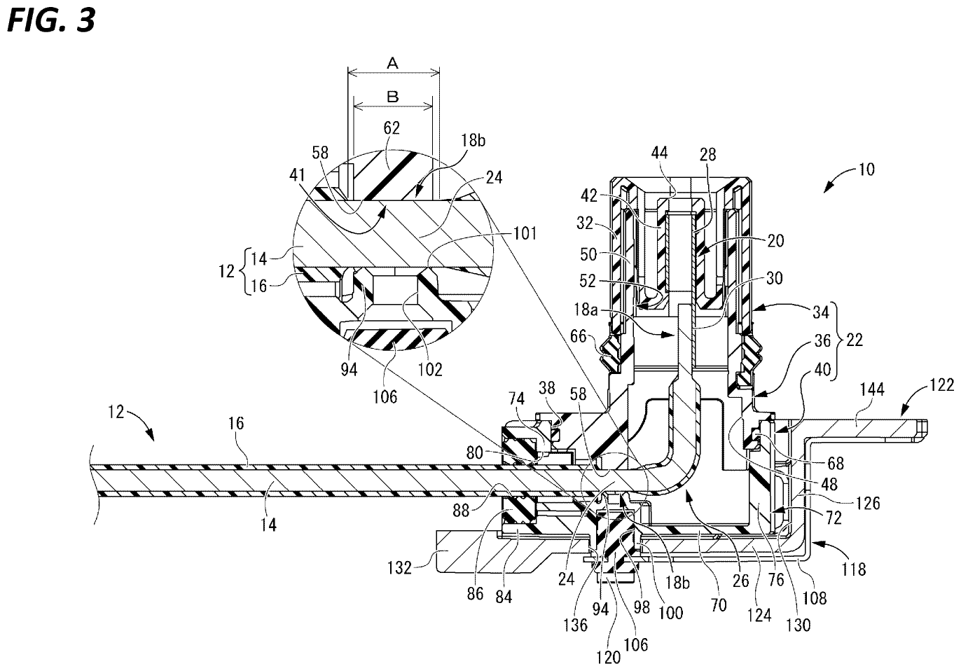

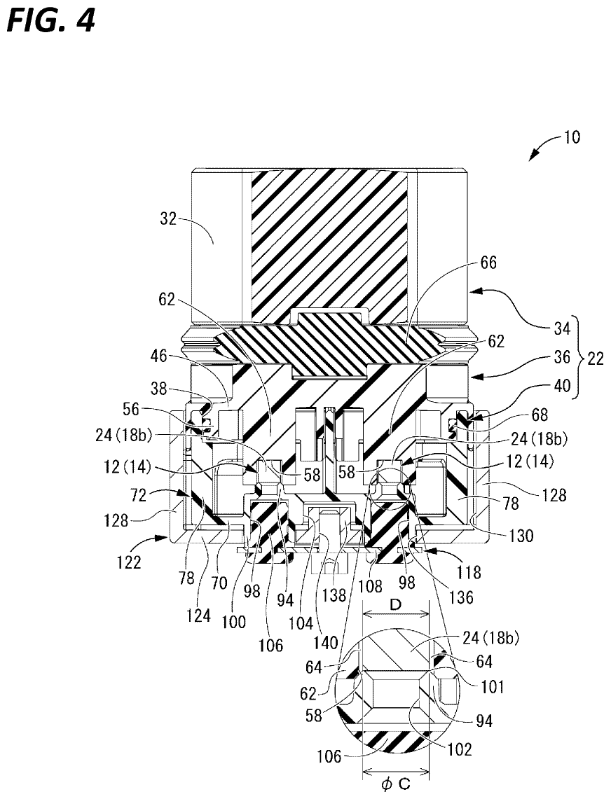

In each wire 12, a strand exposed portion 18b, in which the strands (core wire 14) are exposed by stripping the insulation coating 16, is also provided in a part separated from the end part (upper end part). In this embodiment, the strand exposed portion 18b is provided in front of a rear end part of a part extending in the front-rear direction, i.e. an upwardly curved part in each wire 12. Each of these strand exposed portions 18b includes a strand welded portion 24 formed by welding and integrated the plurality of strands. Each strand welded portion 24 has a substantially rectangular cross-section as also shown in FIGS. 3 and 4, and extends in the front-rear direction, which is an axial direction of the wire 12, at the formation position of the strand welded portion 24. In this embodiment, the strand welded portion 24 has a predetermined dimension A in the front-rear direction (see FIG. 3). Note that a method for forming the strand welded portion 24 by welding and integrating the plurality of strands is not limited and a conventionally known welding method can be adopted, but the strand welded portion 24 is formed by ultrasonic welding in this embodiment.

As described above, a part curved upward from the rear end part of the part extending in the front-rear direction is provided between the strand exposed portion 18a in the end part (upper end part) of each wire 12 and the strand exposed portion 18b in the part separated from the end part, and a tolerance absorbing portion 26 capable of being curved and deformed in each wire 12 is provided to include the curved part.

### Terminal Fitting 20

The terminal fitting 20 is made of metal and includes a contact point portion 28 substantially in the form of a tube open in the vertical direction. A tab-like terminal of the mating in-vehicle device is inserted into this contact point portion 28 and the contact point portion 28 and the mating terminal contact each other, whereby each terminal fitting 20 of the connector 10 and the terminal of the mating in-vehicle device are electrically connected. A part in the form of a flat plate extending in the vertical direction is provided in a lower end part of each contact point portion 28. This part having a flat plate shape is a wire connecting portion 30, and fixed to the strand exposed portion 18a in the upper end part of each wire 12.

### Connector Housing 22

The connector housing 22 is made of insulating synthetic resin. As also shown in FIG. 6 and the like, the connector housing 22 of this embodiment is composed of a plurality of members and provided with a tubular housing 34 having a substantially tubular peripheral wall 32, an upper housing 36 serving as a first resin component to be assembled with the tubular housing 34, and a lower housing 40 serving as a second resin component having an upper opening 38 to be covered by the upper housing 36. The connector housing 22 includes wire press-fit portions 41, into which the respective wires 12 are press-fit.

As also shown in FIG. 3, the tubular housing 34 is provided with holding tube portions 42 substantially in the form of rectangular tubes extending in the vertical direction on an inner peripheral side of the peripheral wall 32, and the contact point portions 28 of the terminal fittings 20 are inserted and held in the holding tube portions 42 when the connector 10 is assembled. In this embodiment, since a pair of the terminal fittings 20, 20 are provided, a pair of the holding tube portions 42, 42 are provided side by side in the lateral direction in the tubular housing 34. Since the terminal of the mating in-vehicle device is assembled with the contact point portion 28 held in this holding tube portion 42 from above, an upper opening of the holding tube portion 42 is a terminal assembly opening 44, through which the mating terminal is assembled.

Note that unillustrated substantially frame-like engaging frame bodies are provided on both sides in the front-rear direction on the inner peripheral surface of the peripheral wall 32, and these engaging frame bodies are engaged with unillustrated engaging protrusions provided on both sides in the front-rear direction on the inner peripheral surface of a tubular portion 50 in the upper housing 36 to be described later, whereby the tubular housing 34 is assembled with the upper housing 36.

### First Resin Component (Upper Housing 36)

The upper housing 36 includes a lid plate portion 46 extending in a perpendicular direction (direction orthogonal to the vertical direction), and the lid plate portion 46 is formed in such a size as to be able to cover the upper opening 38 of the lower housing 40. The lid plate portion 46 is formed with a through hole 48 penetrating in a thickness direction (vertical direction), and the tubular portion 50 having a substantially tubular shape and projecting upward is formed on an outer peripheral edge part of this through hole 48. In short, an inner hole of the tubular portion 50 extending in the vertical direction and the through hole 48 provided in the lid plate portion 46 communicate with each other to form a communication hole 52 penetrating through the tubular portion 50 and the lid plate portion 46 in the vertical direction. Note that the through hole 48 and the tubular portion 50 are provided in a rear part of the lid plate portion 46. Further, resilient lock pieces 54 projecting downward are provided on both sides in the lateral direction in the lid plate portion 46.

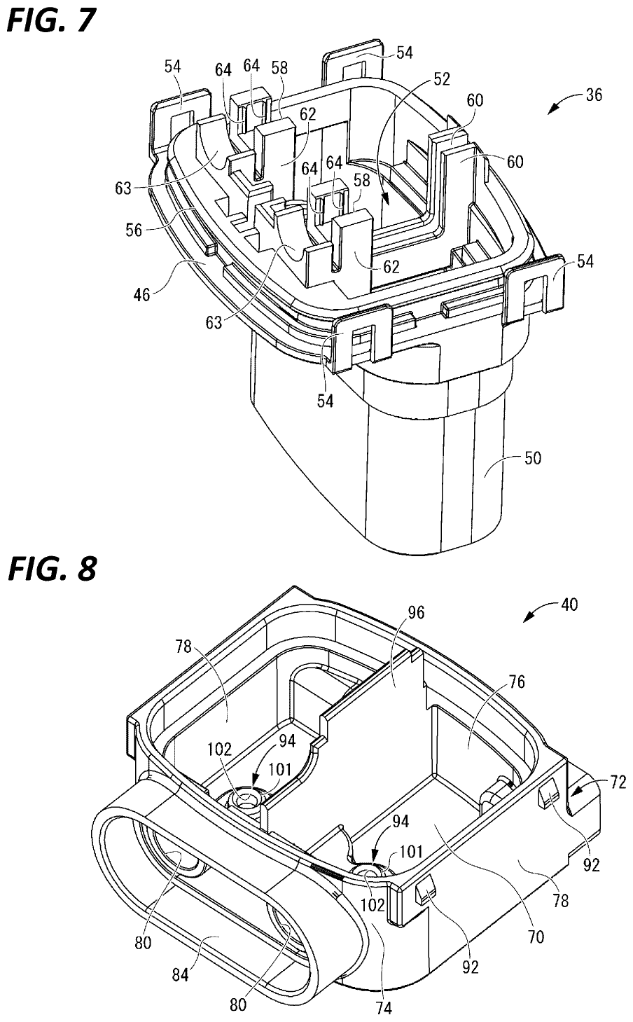

As also shown in FIGS. 4 and 7, a substantially tubular inner insertion tube portion 56 to be inserted into the lower housing 40 when the upper housing 36 is assembled with the lower housing 40 is provided on the lower surface of the lid plate portion 46 in the upper housing 36. That is, the inner insertion tube portion 56 projecting downward is provided on an outer peripheral part of the lid plate portion 46, and an inner hole of the inner insertion tube portion 56 also communicates with the communication hole 52 in the upper housing 36. Note that the communication hole 52 extends substantially in the vertical direction, and the inner hole of the inner insertion tube portion 56 and the communication hole 52 communicate with each other in a rear part of the inner hole of the inner insertion tube portion 56. Groove portions 58 constituting the wire press-fit portions 41 are provided in a front part of the inner hole of the inner insertion tube portion 56.

Specifically, a pair of partition plate portions 60, 60 separated from each other in the lateral direction in a lateral central part are provided in the upper housing 36, and the upper housing 36 is partitioned into left and right sides by these partition plate portions 60. A wire holding portion 62 projecting downward and having a substantially rectangular cross-section is provided in the front part of the inner hole of the inner insertion tube portion 56 on each of the both left and right sides of the upper housing 36 partitioned by the respective partition plate portions 60. The groove portion 58 open downward and extending in the front-rear direction is formed in the lower end surface of each of these wire holding portions 62. That is, a bottom part of the groove portion 58 is constituted by an upper wall portion constituting the inner surface of the groove portion 58.

The groove portion 58 has a cross-sectional shape substantially similar to that of the strand welded portion 24 in each wire 12, and extends in the front-rear direction, which is an axial direction of a press-fit part (strand welded portion 24 as described later) in each wire 12. In this embodiment, the groove portion 58 (wire press-fit portion 41) has a predetermined dimension B in the front-rear direction (see FIG. 3). Particularly, in this embodiment, the dimension B in the front-rear direction of the groove portion 58 is smaller than the dimension A in the front-rear direction of the strand welded portion 24. Further, in the lower surface of the upper housing 36, upper half tubular portions 63 having curved inner peripheral surfaces for covering upper halves of the respective wires 12 with the respective wires 12 assembled with the connector housing 22 are provided in front of the respective wire holding portions 62.

Further, in each groove portion 58, crush ribs 64 extending in the vertical direction are provided on inner surfaces on both sides in the lateral direction, which are facing surfaces facing each strand welded portion 24 when each strand welded portion 24 to be described later is accommodated. These crush ribs 64 are provided substantially over the entire lengths in the vertical direction of the inner surfaces on the both lateral sides in each groove portion 58. In this embodiment, two crush ribs 64, 64 are provided apart from each other in the front-rear direction on the inner surface on each of the both lateral sides in each groove portion 58. By providing these crush ribs 64, each crush rib 64 and/or each strand welded portion 24 is/are inserted while being slightly compressed and each strand welded portion 24 is inserted substantially in a press-fit state into each groove portion 58 when each strand welded portion 24 is inserted into each groove portion 58.

Note that the tubular portion 50 of the upper housing 36 is inserted into the inside of the peripheral wall 32 of the tubular housing 34 to assemble the upper housing 36 and the tubular housing 34. On the outer peripheral surface of the tubular portion 50, an annular waterproof rubber 66 is externally mounted between the upper housing 36 and the tubular housing 34 in the vertical direction. In this way, water intrusion through an assembled part of the upper housing 36 and the tubular housing 34 is prevented. Further, an O-ring 68 is mounted on the outer peripheral surface of the inner insertion tube portion 56 to be inserted into the lower housing 40. This O-ring 68 is compressed between the inner insertion tube portion 56 and the lower housing 40, whereby water intrusion through an assembled part of the upper housing 36 and the lower housing 40 is prevented.

### Second Resin Component (Lower Housing 40)

The lower housing 40 has a substantially rectangular box shape open upward as a whole and includes a bottom wall portion 70 and a peripheral wall portion 72 projecting upward from an outer peripheral edge part of the bottom wall portion 70. That is, the peripheral wall portion 72 includes a front wall 74, a rear wall 76 and side walls 78, 78 on both left and right sides, any of these walls extending in the vertical direction. The front wall 74 is formed with substantially circular wire pull-out openings 80 penetrating in a thickness direction (front-rear direction). Since the pair of wires 12, 12 are provided in this embodiment, a pair of the wire pull-out openings 80, 80 are formed side by side in the lateral direction in the front wall 74.

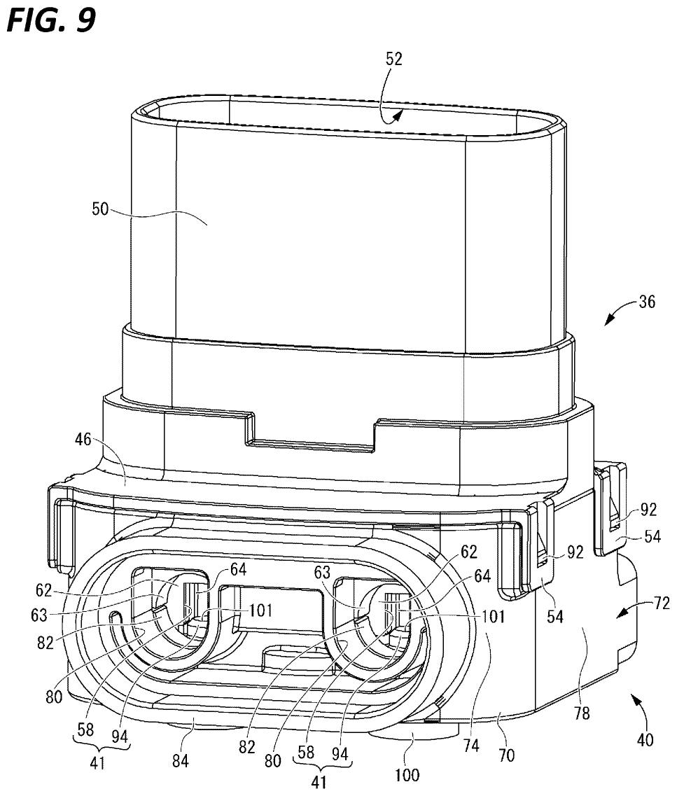

Further, as also shown in FIG. 9, lower half tubular portions 82 having curved inner peripheral surfaces for covering lower halves of the respective wires 12 with the respective wires 12 assembled with the connector housing 22 are provided behind the front wall 74 in the lower housing 40. In this embodiment, a pair of the lower half tubular portions 82, 82 are provided apart from each other in the lateral direction. When the upper housing 36 and the lower housing 40 are assembled with each other, the respective upper half tubular portions 63 in the upper housing 36 and the respective lower half tubular portions 82 in the lower housing 40 face each other in the vertical direction and constitute substantially circular through holes. Further, the front wall 74 is provided with an accommodating tube portion 84 projecting forward, and a pair of the wire pull-out openings 80, 80 are covered from outside by this accommodating tube portion 84. The accommodating tube portion 84 has an outer shape long in the lateral direction and has a substantially rectangular shape with rounded corner or a substantially oval shape.

A waterproof rubber 86 made of a resilient material such as rubber is accommodated into this accommodating tube portion 84. The waterproof rubber 86 is shaped to substantially correspond to the accommodating tube portion 84, and formed with insertion holes 88, 88 penetrating in the thickness direction at positions corresponding to the wire pull-out openings 80, 80 in the front wall 74. The waterproof rubber 86 is formed to be slightly larger than the accommodating tube portion 84, and assembled substantially in a compressed state with the accommodating tube portion 84 when the connector 10 is assembled. In this way, water intrusion into the connector housing 22 through the respective wire pull-out openings 80 is prevented.

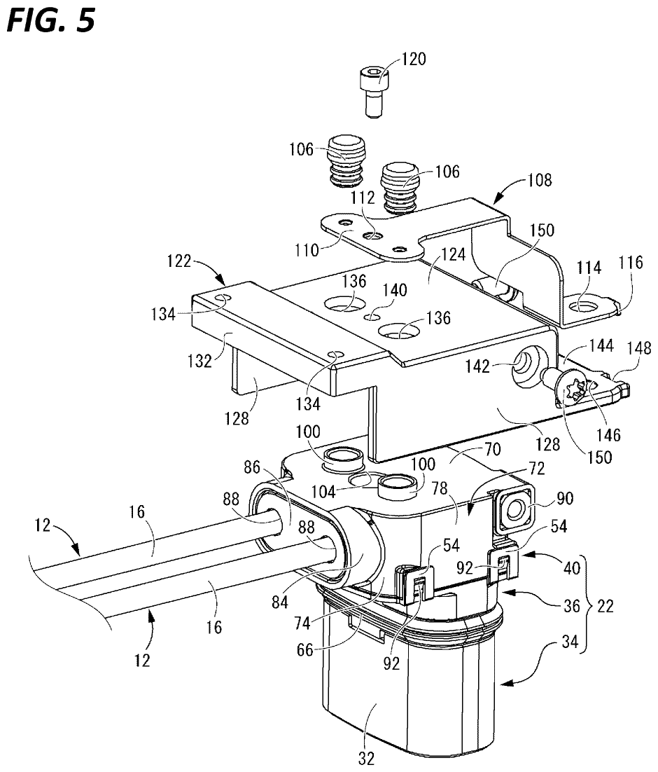

As shown in FIGS. 5 and 6, nuts 90, to which bolts 150 are fastened when a shield shell 122 to be described later is fixed to the connector housing 22, are provided substantially in an embedded state in the rear wall 76 and the left side wall 78. Further, lock claws 92 to be engaged with the respective resilient lock pieces 54 of the upper housing 36 when the upper housing 36 is assembled are provided on an upper end part of the outer surface of each side wall 78.

Here, pressing protrusions 94 constituting the wire press-fit portions 41 are provided in a front part of the bottom wall portion 70. Specifically, the lower housing 40 is provided with a partition plate portion 96 in a lateral central part, and the lower housing 40 is partitioned into both left and right sides by this partition plate portion 96. Through holes 98 penetrating through the bottom wall portion 70 in a thickness direction (vertical direction) are formed in the front part of the bottom wall portion 70 on the both left and right sides of the lower housing 40 partitioned by the partition plate portion 96, and a hollow cylindrical portion 100 projecting toward both sides in the vertical direction is provided on a peripheral edge part of each through hole 98.

That is, each hollow cylindrical portion 100 is open on sides more outward than the bottom wall portion 70 in the vertical direction, and each pressing protrusion 94 is integrally formed to an upper opening in each hollow cylindrical portion 100. In this embodiment, each pressing protrusion 94 has a substantially hollow cylindrical shape and, particularly, an upper end part of each pressing protrusion 94 is formed to gradually reduce a radial width toward upside. In this way, when each pressing protrusion 94 presses the strand welded portion 24 in each wire 12 as described later, a pressing force by each pressing protrusion 94 is enhanced.

Particularly in this embodiment, a crush rib 101 resiliently deformable by being contacted by the strand welded portion 24 is formed on the upper end surface (projecting end surface) of each pressing protrusion 94 serving as a contact surface with the strand welded portion 24 in each wire 12. In this way, when each pressing protrusion 94 is pressed against each strand welded portion 24 as described later, each strand welded portion 24 and/or each crush rib 101 is/are compressed and deformed and each strand welded portion 24 can be stably supported in the vertical direction between the upper wall portion constituting each groove portion 58 and each pressing protrusion 94 (each crush rib 101).

Note that, in this embodiment, an outer diameter ϕC (see FIG. 4) of the upper end of each pressing protrusion 94 is substantially equal to or slightly smaller than a width (lateral dimension) D (see FIG. 4) of each strand welded portion 24. Further, as shown in FIG. 3, the outer diameter ϕC of the upper end of each pressing protrusion 94 is smaller than a length (dimension in the front-rear direction) B of each groove portion 58.

A voltage detection hole 102 penetrating through the inside of each pressing protrusion 94, open in the projecting end surface of each pressing protrusion 94 and the surface of the connector housing 22 and exposing the strand welded portion 24 to outside is configured by the inner hole of each pressing protrusion 94. In short, each voltage detection hole 102 is open in the lower surface of the connector housing 22 (bottom wall portion 70 in the lower housing 40) through the inner hole of each hollow cylindrical portion 100. Accordingly, in this embodiment, each voltage detection hole 102 includes the inner hole of the pressing protrusion 94 and the inner hole of the hollow cylindrical portion 100. Note that a circular recess 104 open downward is formed between the respective hollow cylindrical portions 100 projecting downward in the lateral direction in the lower surface of the bottom wall portion 70.

Each of these voltage detection holes 102 can be sealed by a plug member 106. Each plug member 106 has a substantially cylindrical shape as a whole and is, for example, made of a resilient material such as rubber. An maximum outer diameter of a part of each plug member 106 to be inserted into the voltage detection hole 102 is larger than an inner diameter of the hollow cylindrical portion 100 constituting the voltage detection hole 102, and each plug member 106 is fixed to the voltage detection hole 102 by inserting each plug member 106 in a press-fit state into the voltage detection hole 102 from below.

Further, each of these plug members 106 is assembled with a plug member holder 108 for holding the respective plug members 106. The plug member holder 108 extends in the front-rear direction as a whole while being bent along a bottom wall 124, a rear wall portion 126 and an external connection portion 144 of the shield shell 122 and is, for example, made of metal. That is, in one end part (front end part) of the plug member holder 108, a holding portion 110 for holding the respective plug members 106 is provided and a bolt insertion hole 112, through which a bolt 120 to be described later is inserted, is formed in a lateral central part of the holding portion 110. Further, in the other end part (rear end part) of the plug member holder 108, a bolt insertion hole 114 is formed and the bolt insertion hole 114 and a bolt insertion hole 146 in the external connection portion 144 communicate with each other when the plug member holder 108 is fixed to the shield shell 122. Further, a claw portion 116 is formed on the other end part (rear end part) of the plug member holder 108, and the claw portion 116 is engaged with a positioning portion 148 provided on the rear end part of the external connection portion 144 when the plug member holder 108 is fixed to the shield shell 122 to be described later.

In this embodiment, these plug members 106 and plug member holder 108 are integrally formed to configure a voltage detection hole sealing member 118. This voltage detection hole sealing member 118 is overlapped on and fixed to the connector housing 22 via the shield shell 122 to be described later from below, and the respective voltage detection holes 102 are sealed by the respective plug members 106. That is, the respective plug members 106 are press-fit into the respective voltage detection holes 102 (respective hollow cylindrical portions 100) open downward via insertion holes 136 of the shield shell 122 to be described later, the claw portion 116 is engaged with the positioning portion 148 on the external connection portion 144, and the bolt 120 is inserted through the bolt insertion hole 112 and tightened into a bolt hole 140 in the shield shell 122, whereby the voltage detection hole sealing member 118 can be fixed to the shield shell 122. In short, the respective voltage detection holes 102 are open downward through the respective insertion holes 136 in the shield shell 122 by unfastening the bolt 120 from the shield shell 122, gripping the voltage detection hole sealing member 118 (plug member holder 108) and pulling out the respective plug members 106 from the respective voltage detection holes 102 (respective hollow cylindrical portions 100).

### Shield Shell 122

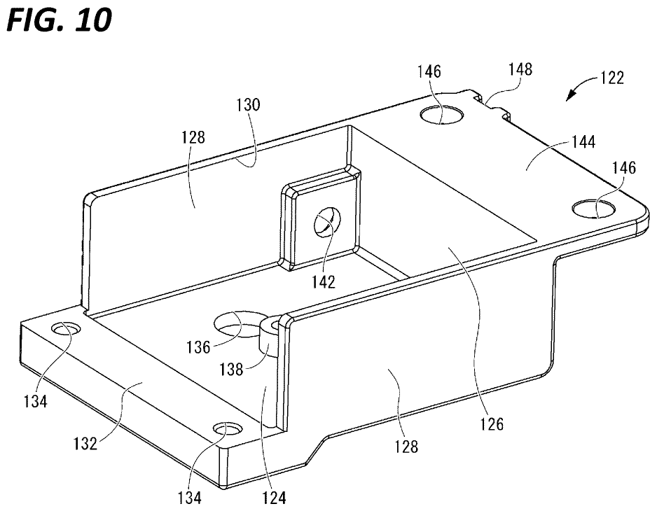

As also shown in FIG. 1 and the like, a lower part of the connector housing 22 structured as described above is accommodated into the shield shell 122 made of metal. As also shown in FIG. 10, the shield shell 122 has a substantially box shape open upward as a whole and is provided with the bottom wall 124 substantially rectangular in a plan view and the rear wall portion 126 and a pair of side wall portions 128, 128 projecting upward from a rear side and both left and right sides of an outer peripheral edge part of the bottom wall 124. An accommodation recess 130 for accommodating the connector housing 22 is constituted by a region surrounded by the bottom wall 124, the rear wall portion 126 and the pair of side wall portions 128, 128.

Note that, in this embodiment, a front part of the bottom wall 124 extends further forward than the respective side wall portions 128, and a front extending portion 132 is constituted by this extending part. An unillustrated retainer for preventing the detachment of the waterproof rubber 86 from the accommodating tube portion 84 in the connector housing 22 can be fixed to this front extending portion 132. The structure of this retainer is not limited, and a conventionally known structure can be adopted, but a vertically dividable structure for sandwiching and supporting the respective wires 12 projecting forward from the accommodating tube portion 84 from outer sides in the vertical direction may be adopted. The front extending portion 132 is formed with bolt holes 134, into which unillustrated bolts can be tightened. By placing the retainer on the front extending portion 132 and tightening the bolts into the bolt holes 134, the retainer may be bolt-fixed to the shield shell 122.

Further, in the shield shell 122, the bottom wall 124 to be overlapped on the bottom wall portion 70 of the connector housing 22 is formed with the insertion holes 136, through which the respective hollow cylindrical portions 100 projecting downward from the bottom wall portion 70 are inserted and which penetrate through the bottom wall 124 in the thickness direction (vertical direction). These insertion holes 136 are formed at positions corresponding to the respective hollow cylindrical portions 100, and a pair of the insertion holes 136, 136 are provided apart from each other in the lateral direction. A hollow cylindrical circular protrusion 138 projecting upward from the bottom wall 124 is provided between the respective insertion holes 136 in the lateral direction, and the bolt hole 140, into which the aforementioned bolt 120 can be tightened, is constituted by an inner hole of this circular protrusion 138.

Further, bolt insertion holes 142 (bolt insertion hole in the rear wall portion 126 is not shown), through which the bolts 150 to be described later are inserted, are provided at positions corresponding to the nuts 90 provided in the rear wall 76 and the left side wall 78 of the connector housing 22 in the rear wall portion 126 and the left side wall portion 128 in the shield shell 122. An upper end part of the rear wall portion 126 is provided with the external connection portion 144 projecting rearward, and the external connection portion 144 is formed with the bolt insertion holes 146 penetrating in the thickness direction (vertical direction). By placing terminal portions provided on ends of unillustrated external wires or the like and inserting and tightening unillustrated bolts into the respective bolt insertion holes 146 in this external connection portion 144, the shield shell 122 and the external wires or the like are electrically connected. Further, the positioning portion 148 engageable with the claw portion 116 of the voltage detection hole sealing member 118 is formed on a left end part of the rear end surface of the external connection portion 144. The positioning portion 148 is configured to have a relatively concave shape by both sides in the lateral direction of an engaged position of the claw portion 116 projecting rearward.

### Assembly Method of Connector 10

A specific example of an assembly method of the connector 10 is described below. Note that the assembly method of the connector 10 is not limited to the one described below.

First, the insulation coating 16 is stripped in the end part and at the position separated from the end part in each wire 12 to form the respective strand exposed portions 18a, 18b. Subsequently, each terminal fitting 20 is fixed to the strand exposed portion 18a in the end part of each wire 12 by welding, adhesion or the like. Further, ultrasonic welding is applied to the strand exposed portion 18b at the position separated from the end part of each wire 12 to form the strand welded portion 24.

Thereafter, the strand welded portion 24 in each wire 12 is inserted substantially in a press-fit state into each groove portion 58 in the upper housing 36, each wire 12 is curved at the tolerance absorbing portion 26 in each wire 12, and the end part on the side fixed to the terminal fitting 20 in each wire 12 is inserted into the communication hole 52 in the upper housing 36. Then, the upper and lower housings 36, 40 are caused to face each other in the vertical direction while the end part of each wire 12 on a side opposite to the side fixed to the terminal fitting 20 is inserted through each wire pull-out opening 80 in the lower housing 40. Thereafter, the upper and lower housings 36, 40 are brought closer to each other in the vertical direction and fixed to each other by engaging the respective resilient lock pieces 54 in the upper housing 36 and the respective lock claws 92 in the lower housing 40. Further, the end part of each wire 12 on the side opposite to the side fixed to the terminal fitting 20 is inserted into the insertion hole 88 in the waterproof rubber 86 and the waterproof rubber 86 is accommodated into the accommodating tube portion 84 in the lower housing 40. Further, the waterproof rubber 66 and the tubular housing 34 are assembled with the upper housing 36 from above. In this way, the connector housing 22 assembled with the respective wires 12 is completed.

With the respective wires 12 assembled with the connector housing 22 in this way, the respective pressing protrusions 94 projecting upward in the lower housing 40 are pressed against the respective strand welded portions 24 inserted in the respective groove portions 58 from below. In short, the respective strand welded portions 24 are pressed toward the bottom parts (upper wall portions) of the respective groove portions 58 by the respective pressing protrusions 94, and the respective strand welded portions 24 are slightly compressed in the vertical direction between the bottom parts (upper wall portions) of the respective groove portions 58 and the respective pressing protrusions 94. That is, the upper and lower housings 36, 40 are assembled in the vertical direction, which is an approach direction of the respective pressing protrusions 94 toward the respective groove portions 58, and the respective strand welded portions 24 are sandwiched between the respective groove portions 58 and the respective pressing protrusions 94. In this way, the crush ribs 101 provided on the projecting tips of the respective pressing protrusions 94 are pressed into contact with the respective strand welded portions 24. Particularly, in this embodiment, the respective strand welded portions 24 are compressed in the vertical direction as shown in FIG. 4, whereby upper end parts of the respective pressing protrusions 94 are in contact with lower openings of the respective groove portions 58.

Subsequently, the retainer is fixed to the parts of the respective wires 12 projecting forward from the connector housing 22, and the lower part of the connector housing 22 is accommodated into the accommodation recess 130 in the shield shell 122. Then, the retainer and the shield shell 122 are, for example, bolt-fixed. Further, the shield shell 122 and the connector housing 22 are fixed by the bolts 150 by inserting and fastening the bolts 150 to the respective nuts 90 provided in the connector housing 22 from behind and left of the shield shell 122. Note that, when the bottom wall 124 of the shield shell 122 and the bottom wall portion 70 of the connector housing 22 are overlapped and the connector housing 22 is accommodated into the accommodation recess 130, the respective hollow cylindrical portions 100 are inserted into the respective insertion holes 136 and the circular protrusion 138 is inserted into the circular recess 104. Therefore, a positioning effect of the shield shell 122 and the connector housing 22 can be exhibited by the respective insertion holes 136 and the respective hollow cylindrical portions 100, and the circular protrusion 138 and the circular recess 104.

Thereafter, the respective voltage detection holes 102 are sealed by the respective plug members 106 by overlapping the voltage detection hole sealing member 118 on the shield shell 122 from below and tightening the bolt 120. In this way, the connector 10 is completed.

According to the connector 10 of this embodiment, the strand exposed portion 18b is provided at the position separated from the end part in each wire 12, and the stands in this strand exposed portion 18b are welded and integrated to form the strand welded portion 24. In this way, deformation rigidity is improved in the strand welded portion 24 in each wire 12, and bending deformation in each strand welded portion 24 is suppressed. When each wire 12 is assembled with the connector housing 22, the strand welded portion 24 of each wire 12 is press-fit and held in each wire press-fit portion 41 in the connector housing 22. In this way, even when an external force is input from the end part on the side opposite to the side provided with the terminal fitting 20 in each wire 12, this external force is not only blocked by the strand welded portion 24, but also a displacement of each wire 12 in the connector housing 22 is suppressed and a possibility of sliding wear between contact points of each terminal fitting 20 and the mating terminal connected to each terminal fitting 20 can be reduced.

Each wire press-fit portion 41 includes the groove portion 58 and the pressing protrusion 94 and, with each wire 12 assembled with the connector housing 22, the strand welded portion 24 accommodated in the groove portion 58 is pressed by the pressing protrusion 94. In this way, each wire (each strand welded portion 24) can be stably supported in the vertical direction between the groove portion 58 and the pressing protrusion 94.

Particularly, each groove portion 58 and each strand welded portion 24 have both a rectangular cross-sectional shape, and the cross-sectional shapes of these are substantially similar. In this way, contact areas of the wall portions on the both left and right sides constituting each groove portion 58 and each strand welded portion 24 can be enhanced, and each strand welded portion 24 can be more stably supported in each groove portion 58.

The respective crush ribs 64 projecting toward the strand welded portion 24 are provided on the inner surfaces on the both left and right sides serving as the facing surfaces facing the strand welded portion 24 in each groove portion 58 and, with each strand welded portion 24 accommodated in each groove portion 58, each crush rib 64 and/or each strand welded portion 24 is/are compressed. In this way, when each strand welded portion 24 is accommodated into each groove portion 58, a displacement of each strand welded portion 24 in each groove portion 58 is prevented.

Each groove portion 58 constituting the wire press-fit portion 41 is provided in the upper housing 36, and each pressing protrusion 94 is provided in the lower housing 40. In this way, by bringing the upper and lower housings 36, 40 closer and assembling the upper and lower housings 36, 40 with each strand welded portion 24 accommodated in each groove portion 58, each strand welded portion 24 can be pressed by each pressing protrusion 94.

Particularly, in the fitting state of the resilient lock pieces 54 in the upper housing 36 and the lock claws 92 in the lower housing 40, each crush rib 101 on the projecting tip of each pressing protrusion 94 is pressed into contact with each strand welded portion 24. In this way, for example, even if a projecting dimension of each pressing protrusion 94 is slightly reduced due to a manufacturing error or the like or the lower housing 40 (each pressing protrusion 94) is displaced downward in a separation direction with respect to the upper housing 36 (each groove portion 58) due to a locking gap between each resilient lock piece 54 and each lock claw 92, each pressing protrusion 94 can be stably pressed against each strand welded portion 24 and a state of pressing each strand welded portion 24 can be stably realized.

The connector housing 22 includes the respective voltage detection holes 102 for exposing the respective strand welded portions 24 to outside. In this way, for example, whether or not each wire 12 is in an energized state can be confirmed by inserting a voltage detection probe or the like through each voltage detection hole 102 and bringing the voltage detection probe or the like into contact with the strand welded portion 24. Particularly, by forming each voltage detection hole 102 utilizing the inner hole of each pressing protrusion 94, each voltage detection hole 102 and each pressing protrusion 94 need not be separately provided and the lower housing 40 and, consequently, the connector 10 can be reduced in size.

Further, the respective plug members 106 for sealing the respective voltage detection holes 102 and the plug member holder 108 for holding the respective plug members 106 are provided. In this embodiment, these plug members 106 and plug member holder 108 are integrally provided to configure the voltage detection hole sealing member 118. In this way, the opening and closing of the respective voltage detection holes 102 are switched by mounting or removing the voltage detection hole sealing member 118 on or from the shield shell 122. Since the small plug members 106 are not individually mounted and removed, handleability and workability are improved.

In each wire 12, the tolerance absorbing portion 26 capable of being curved and deformed is provided between the strand exposed portion 18a in the end part and the strand exposed portion 18b (strand welded portion 24) at the position separated from the end part. In this way, even if the strand welded portion 24 improved in deformation rigidity is provided in an intermediate part of each wire 12, a position shift of each terminal fitting 20 can be suppressed and each terminal fitting 20 and the mating terminal can be stably connected by properly curving and deforming the tolerance absorbing portion 26. Particularly, since the length A of each strand welded portion 24 is larger than the length B of each wire press-fit portion 41 (each groove portion 58), each strand welded portion 24 can be stably inserted into each groove portion 58.

### Modifications

Although the embodiment has been described in detail as the specific example of the present disclosure above, the present disclosure is not limited by this specific description. Modifications, improvements and the like within a range in which the aim of the present disclosure can be achieved are also included in the present disclosure. For example, the following modifications of the embodiment are also included in the technical scope of the present disclosure.
(1) In the above embodiment, the strand exposed portions 18a, 18b are provided in the end part and at the position separated from the end part in each wire 12, and parts of each wire 12 other than the respective strand exposed portions 18a, 18b are covered by the insulation coating 16. However, there is no limitation to this. For example, a strand exposed portion may be provided by stripping an insulation coating over a predetermined length from an end part in each wire, i.e. from the end part to a position where a strand welded portion is formed.
(2) There is no limitation to the method for forming the strand welded portion 24 by welding and integrating the plurality of strands. Besides ultrasonic welding illustrated in the above embodiment, a conventionally known welding method such as resistance welding can be adopted.
(3) In the above embodiment, the first resin component (upper housing 36) is provided with the groove portions 58 and the second resin component (lower housing 40) is provided with the pressing protrusions 94. However, a first resin component may be provided with pressing protrusion(s) and a second resin component may be provided with groove portion(s).
(4) In the above embodiment, each voltage detection hole 102 is configured, utilizing the inner hole of each pressing protrusion 94. However, a pressing protrusion and a voltage detection hole may be separately provided and, for example, the pressing protrusion may be solid. Note that voltage detection hole(s) is/are not essential in a connector according to the present disclosure.
(5) In the above embodiment, each voltage detection hole 102 (inner hole of each hollow cylindrical portion 100) of the connector housing 22 is open to outside via each insertion hole 136 in the shield shell 122, and each voltage detection hole 102 is sealed by inserting each plug member 106 into the inner hole of each hollow cylindrical portion 100. However, for example, a voltage detection hole may be sealed by closing an insertion hole of a shield shell. Note that, in a connector according to the present disclosure, the shield shell is not essential and a plug member holder for holding a plug member may be directly fixed to a connector housing.

### LIST OF REFERENCE NUMERALS

10 connector
12 wire
14 core wire (plurality of strands)
16 insulation coating
18, 18a, 18b strand exposed portion
20 terminal fitting
22 connector housing
24 strand welded portion
26 tolerance absorbing portion
28 contact point portion
30 wire connecting portion
32 peripheral wall
34 tubular housing
36 upper housing (first resin component)
38 upper opening
40 lower housing (second resin component)
41 wire press-fit portion
42 holding tube portion
44 terminal assembly opening
46 lid plate portion
48 through hole
50 tubular portion
52 communication hole
54 resilient lock piece
56 inner insertion tube portion
58 groove portion
60 partition plate portion
62 wire holding portion
63 upper half tubular portion
64 crush rib
66 waterproof rubber
68 O-ring
70 bottom wall portion
72 peripheral wall portion
74 front wall
76 rear wall
78 side wall
80 wire pull-out opening
82 lower half tubular portion
84 accommodating tube portion
86 waterproof rubber
88 insertion hole
90 nut
92 lock claw
94 pressing protrusion
96 partition plate portion
98 through hole
100 hollow cylindrical portion
101 crush rib
102 voltage detection hole
104 circular recess
106 plug member
108 plug member holder
110 holding portion
112, 114 bolt insertion hole
116 claw portion
118 voltage detection hole sealing member
120 bolt
122 shield shell
124 bottom wall
126 rear wall portion
128 side wall portion
130 accommodation recess
132 front extending portion
134 bolt hole
136 insertion hole
138 circular protrusion
140 bolt hole
142 bolt insertion hole
144 external connection portion
146 bolt insertion hole
148 positioning portion
150 bolt

1. A connector, comprising:
a wire formed by covering a plurality of strands by an insulation coating;
a terminal fitting connected to an end part of a strand exposed portion, the strands being exposed in the strand exposed portion by stripping the insulation coating in an end of the wire; and
a connector housing for accommodating the terminal fitting and the wire,
the connector housing including a wire press-fit portion,
the strand exposed portion including a strand welded portion formed by welding and integrating the strands, and
the strand welded portion being press-fit and held in the wire press-fit portion.

2. The connector of claim 1, wherein the wire press-fit portion includes a groove portion for accommodating the strand welded portion inserted thereinto and a pressing protrusion for pressing the strand welded portion toward a bottom part of the groove portion.

3. The connector of claim 2, wherein the groove portion of the wire press-fit portion and the strand welded portion extend in an axial direction of the wire while having similar cross-sectional shapes.

4. The connector of claim 2, wherein a crush rib projects on a facing surface of the groove portion facing the strand welded portion.

5. The connector of claim 2, wherein:
the connector housing includes a first resin component having the groove portion and a second resin component having the pressing protrusion, and
the first and second resin components are assembled in an approach direction of the pressing protrusion toward the groove portion and the strand welded portion is sandwiched between the groove portion and the pressing protrusion in the approach direction.

6. The connector of claim 5, wherein:
the first and second resin components are assembled by fitting and locking a resilient lock piece provided on one of the first and second resin components to a lock claw provided on the other,
a crush rib is provided on a contact surface of the pressing protrusion with the strand welded portion, and
the crush rib is pressed into contact with the strand welded portion in a state of the resilient lock piece fit and locked to the lock claw.

7. The connector of claim 2, wherein the connector housing includes a voltage detection hole for exposing the strand welded portion to outside.

8. The connector of claim 7, wherein the voltage detection hole penetrates through inside of the pressing protrusion and is open in a projecting end surface of the pressing protrusion and a surface of the connector housing.

9. The connector of claim 7, further comprising:
a plug member for sealing the voltage detection hole; and
a plug member holder for holding the plug member, the plug member holder being assembled with the connector housing directly or via another member.

10. The connector of claim 1, wherein:
the wire includes a tolerance absorbing portion capable of being curved and deformed between the end part of the strand exposed portion and the strand welded portion,
the wire press-fit portion and the strand welded portion extend in an axial direction of the wire, and
an axial length of the strand welded portion is longer than an axial length of the wire press-fit portion.
